(19) United States
(12) Patent Application Publication
(10) Pub. No.: US 2008/0121682 A1
(43) Pub. Date: May 29, 2008

(54) SYSTEM AND METHOD TO ENHANCE SECURITY SURROUNDING PACKAGE DELIVERY

(75) Inventors: Clifton E. Grim, Seabrook, TX (US); Christopher I. Schmidt, Friendswood, TX (US); Mark B. Stevens, Austin, TX (US); Gary A. Ward, Seabrook, TX (US); John D. Wilson, Houston, TX (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 11/564,392

(22) Filed: Nov. 29, 2006

(51) Int. Cl. A47G 29/122; G06Q 99/00

(52) U.S. Cl. 232/1 R; 705/26

(57) ABSTRACT

Disclosed are a method and a system for the secure delivery of requested, valuable and/or time sensitive packages by authorized delivery agencies, without requiring that the recipient be present. Generally, in accordance with the present invention, a package is delivered to a specially designed receptacle such as a bin or a specially designed mailbox. The receptacle accepts the package if it is an expected package delivered by the expected delivery agency. Two specific implementations of the present invention are disclosed herein. The first has minimal impact on the order and delivery infrastructure existing in the world today. The second implementation is a more integrated approach, but requires that sales and delivery entities implement the interfaces to the secure package delivery bin solution.

### BACKGROUND OF THE INVENTION

1. Field of the Invention

This invention generally relates to methods and systems for delivering packages; and more specifically, the invention relates to a system and method to enhance security surrounding package delivery.

2. Background Art

Secure package delivery is important and becoming more important. One significant concern is that terrorists, or others, may use unsecured containers, such as lockers and mailboxes to deliver bombs or pathological agents. This may result in the extinction of these useful containers unless a means can be invented to better secure them.

No mechanism exists to ensure that only trusted, registered users can use various containers such as lockers, and mailboxes. No package delivery bin design exists to ensure that only packages that have been ordered are allowed to be delivered. If an important package is to be delivered to someone, that person must inconveniently be present to accept the package and sign for it when it arrives. No package delivery bin design exists to automatically report to the sender and receiver when a package has been successfully delivered into the receiver's possession. A delivery bin that would do this would lower the cost and increase the reliability and security of the guaranteed package delivery business.

There are a few procedures or systems that address the above-discussed problem. These include lockable mailboxes, package storefronts, and secure lock boxes. Each of these procedures is not totally effective and has significant disadvantages or inconveniences. For instance, mailboxes are small, are only supposed to be used for US Mail, and every delivery person would have to have a key to every mailbox they could deliver packages to. And even then, there would be no “signing” mechanism as is often required to signify that the recipient acknowledges receipt of the package.

Package storefronts like Mailboxes, Etc. will accept and hold packages for mailbox renters. But these are inconveniently remote from many homes and less secure as many employees are involved in the secure storage of the packages.

PaxZone LLC of Chicago recruits local retailers, such as coffee shops and video stores, to install secure cabinets to hold deliveries. Consumers pick the nearest PaxZone participant to receive their packages, and can stop by any time during business hours. But this is still not to the consumer's door. And dangerous packages still represent a risk to the people at the retail store.

ZBox Company of San Francisco provides a secure lock box to consumers. Each shipment to a zBox is assigned a unique code, and participating shippers include Airborne Express, FedEx, United Parcel Service, and the U.S. Post Office. The zBox creates a new code for each package delivery that must be entered correctly before it will open. This is to the consumer's door but requires management of numbers, does not address multiple deliveries without risking existing packages and does not notify anyone when a delivery is made.

An additional solution is needed to provide secure delivery of requested, valuable and/or time sensitive packages by authorized delivery agencies, without the recipient present. This solution would prevent delivery of possibly dangerous or unwanted packages. The new solution should also provide physical security for the delivered items from subsequent deliverers between recipient pickups.

### SUMMARY OF THE INVENTION

An object of this invention is to provide secure delivery of requested, valuable and/or time sensitive packages by authorized delivery agents, without the recipient present.

Another object of the invention is to provide a secure package delivery system, from purchase at a web site, to package delivery into a secure mailbox, that ensures that only the ordered package, from the online store on which it was ordered, and delivered by only the specified delivery agency, gets delivered into the secure mailbox.

These and other objectives are attained with a method and system for the secure delivery of requested, valuable and/or time sensitive packages by authorized delivery agencies, without requiring that the recipient be present. The invention prevents delivery of possibly dangerous or unwanted packages, and the invention provides physical security for the delivered items from subsequent deliveries between recipient pickups. Generally, in accordance with the present invention, a package is delivered to a specially designed receptacle such as a bin or a specially designed mailbox. The receptacle accepts the package if it is an expected package delivered by the expected delivery agency.

The system of the present invention preferably uses an Identify Services System that provides real-time trusted two party identification. This Identity Services System allows individuals and entities to identify each other based on a confidence level scale. The Identity Services System allows for a continuum of identifying mechanisms—from PINs, passwords, and personal questions to biometrics. One suitable Identity Services System, for example, is disclosed in copending Application No. (Attorney Docket END920060105US1), for “An Identity Assurance Method and System,” filed herewith, the disclosure of which is hereby incorporated herein in its entirety.

Also, in the preferred embodiment of the invention, a physical package delivery “bin” has the following properties:
1. Is built into a structural wall.
2. Is electronically controlled.
3. Is connected to the Internet and Identity Services System.
4. Has an address recognized by package delivery entities.
5. Packages cannot be removed from the outside once delivered.
6. Packages may only be removed from a secure area inside the structure.

Two specific implementations of the present invention are disclosed herein. The first, referred to as the minimal impact solution, has minimal impact on the order and delivery infrastructure existing in the world today. The second implementation, referred to as the integrated solution, is a more integrated approach, but requires that sales and delivery entities implement the interfaces to the secure package delivery bin solution.

With the minimal impact solution, when the bin owner procures an item, the vendor provides the following information to the purchaser:
1. Package ID for the package that the item will be delivered in; and
2. An ID for the package delivery agency.

The owner forwards that information to the “bin” via a web browser or keypad on the bin. The bin accepts the package after verifying the correct package ID and shipper ID. The bin then acknowledges the receipt of the package to the delivering agency and the recipient.

With the more advanced, integrated solution, the bin owner procures an item and provides the vendor/delivery agency with his bin ID and lets the delivery agency take care of sending the package and delivery agency IDs to the bin using standard Internet techniques such as HTTP or web services. This eliminates the need for the bin owner to forward the information and makes the procurement a single transaction.

At the point of delivery, the bin would ask the delivery person to identify himself or herself using an identity services system. The bin then identifies the delivery person, at which time, the system verifies he is from a delivery agency expected by the bin. If the delivery person is expected, the bin would ask the delivery person to identify the package. If the package was expected from the expected delivery agency, the bin then unlocks and requests the delivery person to place the package in the bin. Once there, the bin closes and locks.

The Physically Secure Package Delivery System Invention:
1. Depends on an Identity Services System to identify parties and packages involved. The Identity Services System reports whether it can identify entities within an organization.
2. Allows a person to have important packages delivered securely without having to be present.
3. Allows delivery companies to prove delivery to the correct person without requiring a physical signature.
4. Allows only input of approved packages, securing each item from being taken by subsequent delivery personnel.
5. Holds individuals physically entering system.
6. Retrieval of deliveries is done from a secure area not accessible from the outside.

Further benefits and advantages of this invention will become apparent from a consideration of the following detailed description, given with reference to the accompanying drawings, which specify and show preferred embodiments of the invention.

### BRIEF DESCRIPTION OF THE DRAWINGS

FIG. 1 depicts a secure IP architecture in accordance with one embodiment of the invention.

FIG. 2 describes a second embodiment of the invention.

FIG. 3 describes the first embodiment of the invention.

FIGS. 4(a) and 4(b) show a bin design that may be used in the present invention, in open and locked positions respectively.

FIG. 5 shows an alternate bin design.

### DETAILED DESCRIPTION OF THE PREFERRED EMBODIMENTS

The present invention provides for the secure delivery of requested, valuable and/or time sensitive packages by authorized delivery agencies, without the recipient present. The invention prevents delivery of possibly dangerous or unwanted packages, and the invention provides physical security for the delivered items from subsequent deliveries between recipient pickups.

Generally, in accordance with the present invention, a package is delivered to a specially designed receptacle such as a bin or a specially designed mailbox. The receptacle accepts the package if it is the expected package delivered by the expected delivery agency.

The system of the present invention preferably uses an Identify Services System that provides real-time trusted two party identification. This Identity Services System allows individuals and entities to identify each other based on a confidence level scale. The Identity Services System allows for a continuum of identifying mechanisms—from PINs, passwords, and personal questions to biometrics. As mentioned above, one suitable Identity Services System, for example, is disclosed in copending Application No. (Attorney Docket END920060105US1), for “An Identity Assurance Method and System.”

Also, in one embodiment of the invention, a physical package delivery “bin” has the following properties:
1. Is built into a structural wall.
2. Is electronically controlled.
3. Is connected to the Internet and Identity Services System.
4. Has an address recognized by package delivery entities.
5. Packages cannot be removed from the outside once delivered.
6. Packages may only be removed from a secure area inside the structure.

Two specific implementations of the present invention are disclosed herein. The first, referred to as the minimal impact solution, has minimal impact on the order and delivery infrastructure existing in the world today. The second implementation, referred to as the integrated solution, is a more integrated solution, but requires that sales and delivery entities implement the interfaces to the secure package delivery bin solution.

With the minimal impact solution, when the bin owner procures an item, the vendor provides the following information to the purchaser:
1. Package ID for the package that the item will be delivered in; and
2. An ID for the package delivery agency.

The owner forwards that information to the “bin” via a web browser or keypad on the bin. The bin accepts the package after verifying the correct package ID and shipper ID. The bin then acknowledges the receipt of the package to the delivering agency and the recipient.

With the more advanced, integrated solution, the bin owner procures an item and provides the vendor/delivery agency with his bin ID and lets the delivery agency take care of sending the package and delivery agency IDs to the bin using standard Internet techniques such as HTTP or web services. This eliminates the need for the bin owner to forward the information and makes the procurement a single transaction.

At the point of delivery, the bin asks the delivery person to identify themselves. Using the Identify Services System, fed by one or more methods that may include but not be limited to: key pad entry, RFID, bar codes, body metrics or voice recognition, the bin identifies the delivery person, at which time the system verifies he is from an agency expected by the bin.

If the delivery person was not expected, the bin may provide a way to contact the recipient but not unlock the bin. This event will be recorded in the bin's log and reported to the recipient. If the delivery person is expected, the bin asks the delivery person to identify the package. Using identity methods that may include but not be limited to: key pad entry, RFID, bar codes, or package metrics, the delivery person identifies the package to the bin, and if it was expected from that delivery agency, the bin then unlocks and requests the delivery person to place the package in the bin. Once there, the bin closes and locks, records and reports the transaction to the recipient and the delivery agency. Subsequent deliveries are not able to remove previously delivered packages.

Should someone decide to physically enter the bin, an optional mantrap feature detains individuals by not letting them out of the bin and alerting the owner, the delivery agency and the local authorities. The bin will warn individuals that this will happen if it detects anyone entering the bin. Alternately, a cage can be built around the inside package storage area for the same purpose.

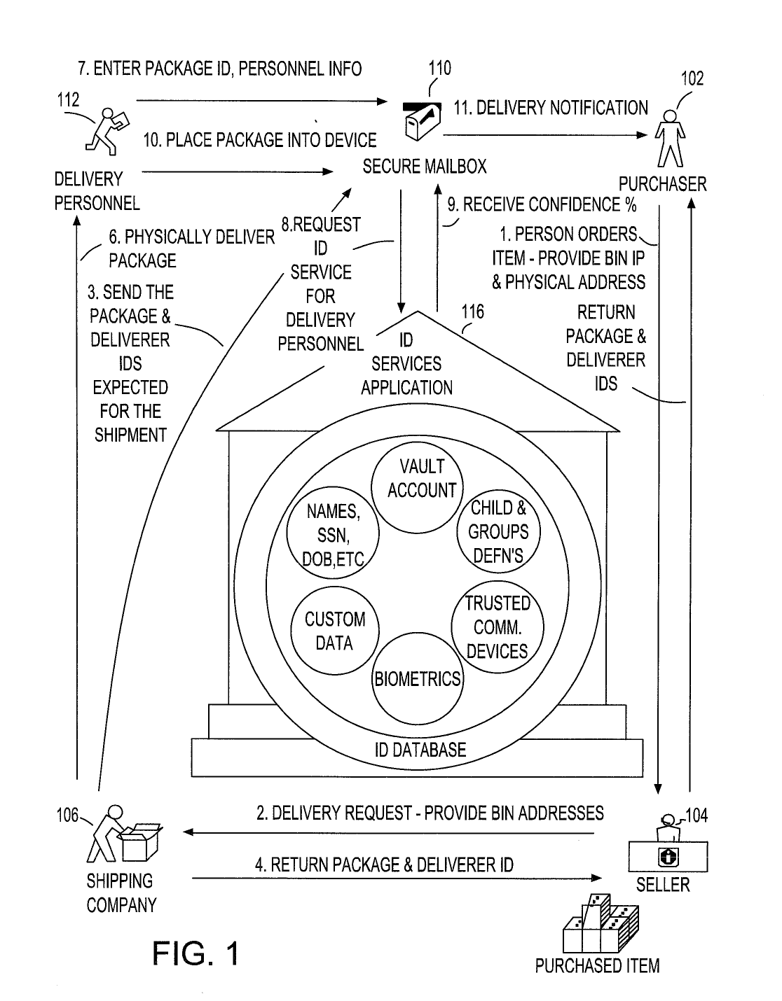

FIG. 1 depicts the architecture of the Integrated Solution. From purchase at a web site to package delivery, this solution ensures that only the package a person ordered, from the online store it was ordered on, and delivered by the delivery agency specified, gets delivered into the secure mailbox.

At step 1 in this process, a person 102 orders an item and provides the bin IP and physical addresses. At step 2, the seller 104 passes the delivery request and provides the bin addresses to the shipping company 106. At step 3, the shipper sends to the secure mailbox 110, the package and deliverer IDs expected for the shipment. At step 4, the shipping company returns the package and deliverer IDs to the seller, who, at step 5, returns this information—that is, the package and deliverer IDs—to the purchaser.

At step 6, the package is physically delivered by delivery personnel 112 who, at step 7, enter the package ID, the badge ID and personnel information to the secure mailbox. At step 8, the mailbox requests ID service for the delivery personnel, and, at step 9, this information is received from an ID services application 116 with a given confidence percentage. At step 10, the package is placed into the secure mailbox, and at step 11, delivery notification is sent to the purchaser.

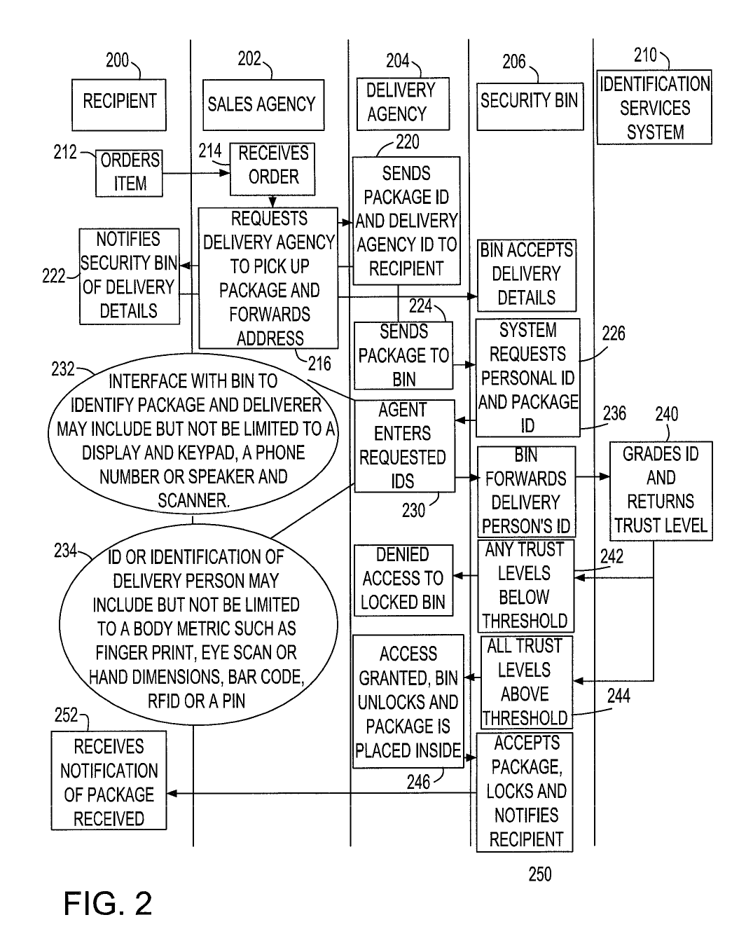

FIG. 2 shows the minimal impact solution. This solution involves a recipient 200, a sales agency 202, a delivery agency 204, a security bin 206, and an identification service system 210. the recipient, at 212, puts in an order to a sales agency providing the physical delivery address, but does not give the bin communications ID. This order is received at 214, and the Sales agency at 216 requests the delivery agency to deliver the package and forwards the physical delivery address. The deliverer assigns the package ID and, at 220, provides it along with the delivery agency ID to the recipient. The recipient, at 222, forwards this information to his/her bin to prime it for this delivery. At step 224, the deliverer arrives at the “Bin” address with the recipient's package. As represented by steps 226, 230, 232, 234, 236, 240, 242, 244, 246 and 250, the vault recognizes the package ID and the deliverer's ID and unlocks to accept the expected package. Once the package is inside the “Bin,” it closes, locks and logs transaction. Once in the bin, the package is no longer reachable from the outside. A validaton message is sent back to the recipient, at 252, detailing what package was delivered to what “bin” and by whom.

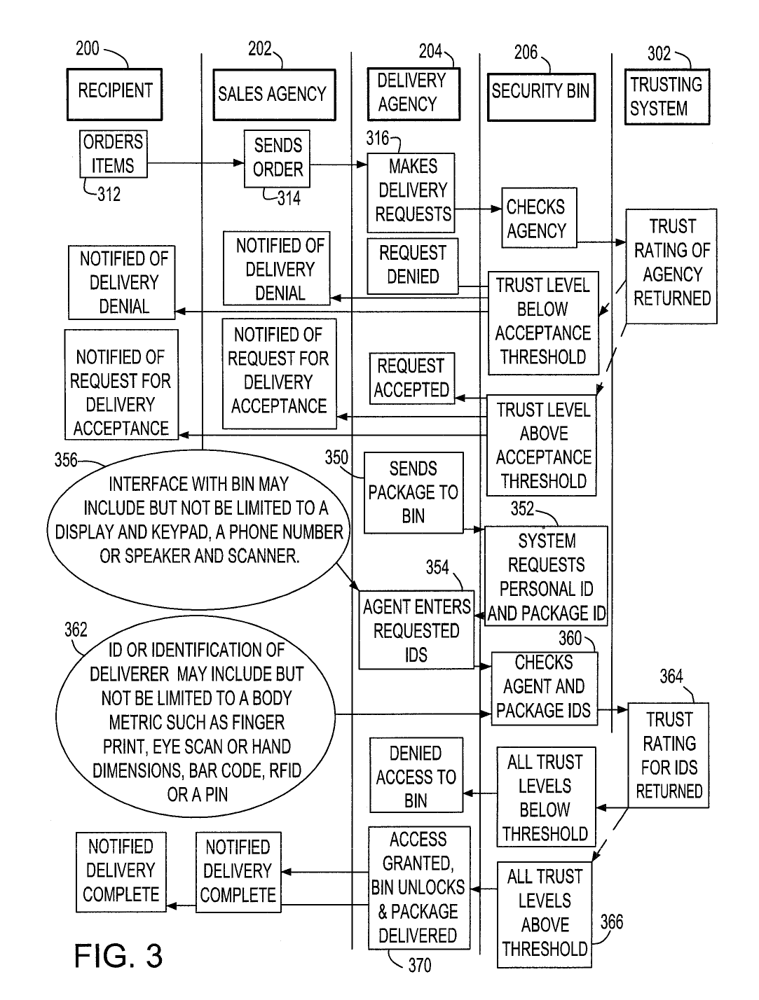

FIG. 3 shows the integrated solution. This solution involves a recipient 200, a sales agency 202, a delivery agency 204, a security bin 206, and a trusting system 302. The recipient and the deliverer must be known by the Identification Services System before transactions may begin. The recipient, at 312, 314 and 316, puts in an order to the deliverer and specifies the “Bin” address. The deliverer tags the package with the package ID and sends the package and the deliver personnel deliverer agency IDs numbers to the “Bin”. The bin validates, logs and acknowledges the deliverer's request to the deliverer and the recipient. The recipient approves the deliverer's request and unlocks the “Bin” for current transaction. The deliverer, at 350, arrives at the “Bin” address with the recipient's package. The vault, via steps 352, 354, 356, 360, 362, 364, 366 and 370, recognizes the package ID and the deliverer's ID and opens to accept the expected package. Once the package is inside the “Bin”, it closes, locks and logs the transaction. Once in the bin, the package is no longer reachable from the outside. A validation message is, at 372 and 374, sent back to the delivery agency and the recipient when the package was delivered to what “Bin” and by whom.

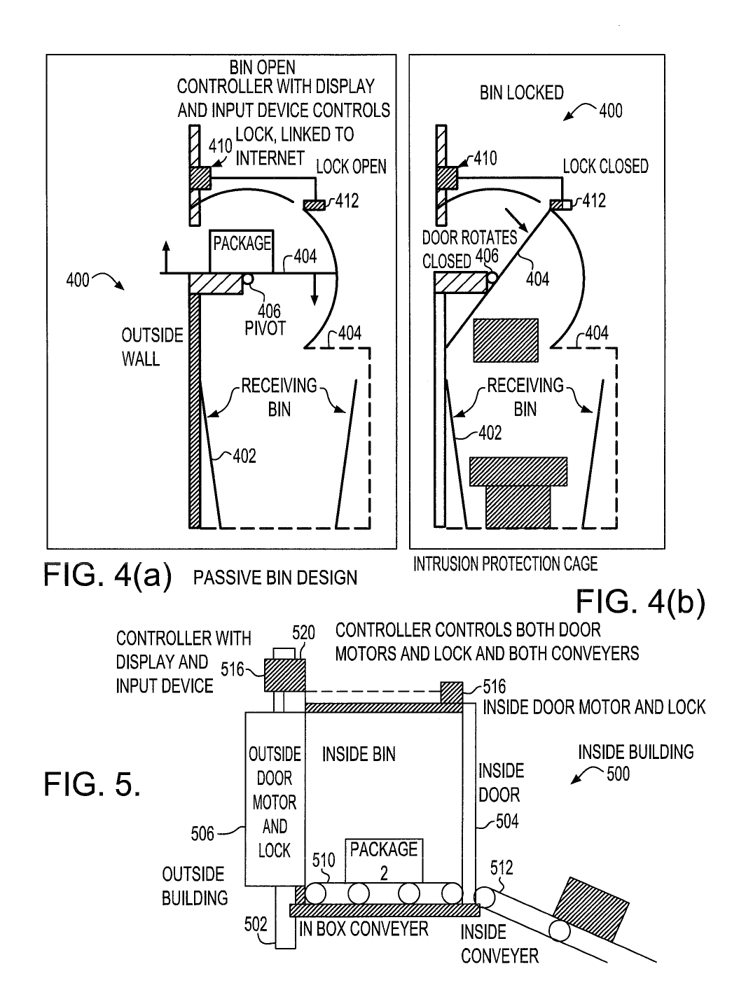

FIGS. 4(a) and 4(b) show a bin 400, in open and locked positions respectively, that may be used in the present invention. This bin includes a receiving bin 402, a door 404, a pivot 406, a controller 410, a lock 412, and an intrusion protection cage 414. The controller has a display and input device, controls lock 412, and is linked to the Internet.

Preferably, the bin has the following properties: it is built into a structural wall, is electronically controlled, is connected to the Internet and to the Identity Services System, has an address recognized by package delivery entities. Also, preferably, packages cannot be removed from the outside once delivered, and packages may only be removed from a secure area inside the structure.

FIG. 5 shows an alternate mechanized bin design 500. This bin is built into a building wall, shown at 502, and includes inside door 504, outside door 506, in box conveyor 510, inside conveyor 512, outside door motor and lock 514, inside door motor and lock 516, and controller 520 with display and input device. The controller controls both door motors and locks and both conveyors.

In normal operation, after the bin verifies the delivery agent and the package, the controller commands the outside door to unlock and open and display and/or an enunciator requests that the package be placed in the bin and to close the door for acceptance. An agent places the package inside. The outside door is closed and locked. The controller commands the inside door to unlock and open. The controller commands the in box conveyer to move the package to the inside conveyer, which carries the package away. The controller closes and locks the inside door. The bin is now ready for another delivery. In a mantrap mode, after the bin verifies the delivery agent and the package, the outside door opens. A person enters the bin with or without a package. The bin detects the person inside, and warns that the system will arrest them if they remain in the bin and close the door. The outside door is closed and locked.

As will be readily apparent to those skilled in the art, aspects of the present invention can be realized in hardware, software, or a combination of hardware and software. Any kind of computer/server system(s)—or other apparatus adapted for carrying out features described herein—is suited. A typical combination of hardware and software could be a general-purpose computer system with a computer program that, when loaded and executed, carries out features described herein. Alternatively, a specific use computer, containing specialized hardware for carrying out one or more of the functional tasks of the invention, could be utilized.

Also, aspects of the invention can be embodied in a computer program product, which comprises all the respective features enabling the implementation of functions described herein, and which—when loaded in a computer system—is able to carry out these functions. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A method of delivering a package, comprising the steps of:
a purchaser ordering an item from a seller;
the purchaser giving the seller an Internet address and a physical address for a receptacle;
the seller giving said Internet address and said physical address to a delivery agency;
the delivery agency sending to the seller an expected package ID and an expected deliverer ID for a shipment;
the seller sending the expected package ID and the expected deliverer ID to the purchaser;
the purchaser sending the expected package ID and the expected deliverer ID to the receptacle;
a deliverer physically delivering a package to the receptacle, said deliverer having an actual deliverer ID and the package having an actual package ID;
the deliverer, at the physical location of the receptacle, inputting to the receptacle, said actual deliverer ID and said actual package ID;
the receptacle comparing said expected deliverer and expected package IDs with said actual deliverer and actual package IDs; and
if the expected deliverer ID matches the actual deliverer ID and if the expected package ID matches said actual package ID, then (i) the receptacle opening, (ii) the deliverer placing the package in the receptacle, and (iii) the receptacle closing and locking.

2. A method according to claim 1, comprising the further steps of:
the deliverer inputting to the receptacle personnel information to identify further the deliverer; and
the receptacle sending said personnel information to an identity services system to confirm the identity of the deliverer: and
wherein the step of the receptacle opening includes the step of the receptacle opening only if said identity services system confirms the identity of the deliverer.

3. A method according to claim 1, wherein the receptacle includes a door, a lock for locking the door in a closed position, and a controller, and wherein the step of the receptacle opening includes the steps of the controller unlocking the lock to unlock the door from the closed position, and moving the door to an open position.

4. A method according to claim 3, wherein the controller includes a processing unit connected to the Internet, and wherein:
the step of the purchaser sending the expected package ID and the expected deliverer ID to the receptacle includes the step of the purchaser sending the expected package ID and the expected deliverer ID to the controller of the receptacle over the Internet.

5. A method according to claim 4, wherein the step of the receptacle opening includes the step of the receptacle opening only if the expected deliverer ID matches the actual deliverer ID and the expected package ID matches the actual package ID.

6. A method according to claim 5, comprising the further step of the controller notifying the recipient and the sales agency of the accomplished delivery.

7. A method of delivering a package, comprising the steps of:
a purchaser ordering an item from a seller;
the purchaser giving the seller an Internet address and a physical address for a receptacle;
the seller giving said Internet address and said physical address to a delivery agency;
the delivery agency sending directly to the receptacle an expected package ID and an expected deliverer ID for a shipment;
a deliverer physically delivering a package to the receptacle, said deliverer having an actual deliverer ID and the package having an actual package ID;
the deliverer, at the physical location of the receptacle, inputting to the receptacle, said actual deliverer ID and said actual package ID;
the receptacle comparing said expected deliverer and expected package IDs with said actual deliverer and actual package IDs; and
if the expected deliverer ID matches the actual deliverer ID and if the expected package ID matches said actual package ID, then (i) the receptacle opening, (ii) the deliverer placing the package in the receptacle, and (iii) the receptacle closing and locking.
